(19) United States
(12) Patent Application Publication
(10) Pub. No.: US 2004/0193573 A1
(43) Pub. Date: Sep. 30, 2004

(54) Downward hierarchical classification of multivalue data

(75) Inventor: Frank Meyer, Lannion (FR)

Correspondence Address: James R. Williams, Jameson, Seltzer, Harper & Williams, 2625 Wilmington Road, New Castle, PA, 16105, US

(73) Assignee: France Telecom, Paris (FR)

(21) Appl. No.: 10/779,858

(22) Filed: Feb. 17, 2004

(30) Foreign Application Priority Data
Feb. 14, 2003 (FR) 0301812

(51) Int. Cl. G06F 7/00

(52) U.S. Cl. 707/1

(57) ABSTRACT

A method of classifying data in a descending hierarchy, in which each datum is associated with particular initial values for attributes that are common to the data, the method comprising recursive steps of subdividing data sets. During each step of subdividing a set, discrete attribute values are calculated from the particular initial attribute values of the data of said set, and said set is subdivided into subsets as a function of the discrete values.

The present invention relates to a method of classifying data in a descending hierarchy, each datum being associated with particular initial values of attributes that are common to the data. More particularly, the invention relates to a method of classification comprising recursive steps of sub-dividing data sets.

### BACKGROUND OF THE INVENTION

The Williams & Lambert method of automatic classification is a method of this type. Nevertheless, it applies to data having attributes that are binary, i.e. attributes that for each datum take a particular “true” or “false” value. In that method, on each step of sub-dividing a set, the chi2 value accumulated over all of the other attributes is calculated for each attribute (where the chi2 value calculated between two attributes enables the linkage between those two attributes to be estimated). Thereafter, the set is subdivided into subsets on the basis of the attribute having the greatest accumulated chi2 value.

That method can be extended to classifying data having attributes that take symbolic values, providing a preliminary step of “binarization” is performed. During this step, each symbolic value that an attribute can take is transformed into a binary attribute. Thereafter, during the recursive steps of subdivision, chi2 values are calculated on contingency matrices of the resulting pairs of binary attributes.

However, that method cannot be applied without major drawbacks to classifying multivalue data comprising a mixture of numerical and symbolic attributes, i.e. data in which some of the attributes are symbolic and other attributes are numerical. In the present document, values are said to be “numerical” when they constitute quantitative values (represented by numbers) and values are said to be “symbolic” when they represent qualitative values (also know as discrete values, e.g. suitable for being represented by letters or words).

For numerical attributes, preliminary discretization of the values over intervals is required so as to make each numerical attribute symbolic. Unfortunately, that transformation inevitably causes information to be lost, without taking into account the fact that the number of discretization intervals will have an influence on the final result, and without it being possible to make a judicious selection of said number of intervals a priori. This affects the coherence of the resulting classes.

In addition, even with attributes that are purely symbolic, the preliminary step of “binarization” considerably increases the number of attributes, thereby considerably increasing the time required to perform the method.

Finally the chi2 calculation is an estimate of the linkage between two attributes, showing up attributes that are correlated or anti-correlated. That calculation thus artificially overestimates the linkage between anti-correlated attributes that result from the binarization step. Since chi2 calculation is also symmetrical between two variables, it does not make it possible to determine whether one variable is more discriminating than another.

### SUMMARY OF THE INVENTION

The invention seeks to remedy those drawbacks by providing a method of classification into a descending hierarchy that is capable of treating multivalue data that are numerical and/or symbolic while optimizing the complexity of the treatment and the coherence of the resulting classes.

The invention thus provides a method of classifying data in a descending hierarchy, each datum being associated with particular initial values of attributes that are common to the data, the method comprising recursive steps of subdividing data sets, and wherein, during each step of subdividing a set, discrete values are calculated for the attributes from the particular initial values of the data attributes of said set, and wherein said set is subdivided into subsets as a function of the discrete values.

While executing a classification method of the invention, new discrete values are calculated for attributes associated with the data that are to be classified at each recursive subdivision step of the method. Since this discretization is not performed once and for all during a preliminary step, no information is lost while executing the method. In addition, on each iteration, a set is subdivided into subsets on the basis of the discrete values for the attributes as calculated on a temporary basis, and as a result the method is simplified.

Optionally, during each step of subdividing a set, binary attribute values are calculated from the particular initial attribute values of the data of said set, and said set is subdivided into subsets as a function of the binary values.

This principle of making each numerical and symbolic attribute discrete on only two values (“binarization”) maximizes the speed with which the algorithm executes without significantly harming its precision on large volumes of data.

A classification method of the invention may further comprise one or more of the following features:

during the step of calculating the binary values for the attributes, for each attribute that is numerical, the median value of the particular initial values of said attribute in the data of said set is estimated, and the value “true” is given to the binary attribute corresponding to said attribute for a datum of said set if the particular initial value of the numerical attribute of said datum is less than or equal to the estimated median value, else the value “false” is given thereto;

the estimated median value of a numerical attribute is obtained as follows:

extracting extreme values from the set of values taken by the numerical attribute for the data of said set;

calculating the mean of the remaining values; and

allocating the value of said mean as the estimated median value;

during the step of calculating the binary values for the attributes, for each attribute that is symbolic the modal value of the particular initial values of said attribute in the data of said set is estimated, and the value “true” is allocated to the binary attribute corresponding to said attribute for a datum of said set if the initial particular value of the symbolic attribute of said datum is equal to the estimated modal value, else the value “false” is given thereto;

the modal value of a symbolic attribute is estimated as follows:

the first m different symbolic values taken by the data of said set for the symbolic attribute are stored, where m is a predetermined number;

the symbolic value that appears most frequently is retained, amongst said m first different symbolic values; and

the retained symbolic value is used as the estimate of the modal value;

said set is subdivided into subsets as a function of a homogeneity criterion calculated on the basis of the discrete values for the attributes of said set;

said set is subdivided on the basis of the discrete values of the most discriminating attribute, i.e. the attribute for which a homogeneity criterion for all of the discrete values of the other attributes in the resulting subsets is optimized;

for any attribute, the homogeneity criterion is an estimate of the expectation of the conditional probabilities for correctly predicting the other attributes, given knowledge of this attribute; and

for certain attributes marked a priori as being “taboo” by means of a particular parameter, the attribute considered as being the most discriminating is the attribute that is not marked as being taboo for which the homogeneity criterion for all of the discrete values of the other attributes in the resulting subsets is optimized.

### BRIEF DESCRIPTION OF THE DRAWINGS

The invention will be better understood from the following description given purely by way of example and made with reference to the accompanying drawings, in which:

FIG. 1 is a diagram showing the structure of a computer system for implementing the method of the invention, and also the structure of the data input to and output by the system; and

FIG. 2 shows the successive steps of the method in accordance with the invention.

### DETAILED DESCRIPTION OF THE INVENTION

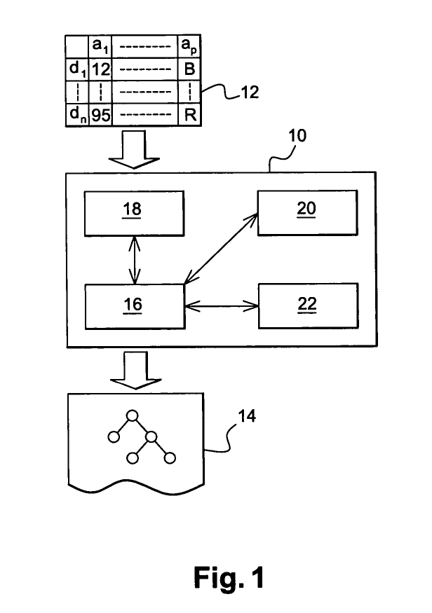

The system shown in FIG. 1 is a conventional computer system comprising a computer 10 associated with random access and read-only type memories RAM and ROM (not shown), for storing data 12 and 14 as input to the computer 10 and as output from the computer 10. The data 12 input to the computer 10 is, for example, stored in the form of a database, or merely in the form of a single file. The data output by the computer 10 is stored in a format making it possible, for implementation of the method of the invention, to represent the data in the form of a tree structure, such as a decision tree 14.

The data 12 is multivalued numerical and/or symbolic data. By way of example, the data may come from a medical or a marketing database, i.e. a database that generally contains several millions of records each associated with several tens of numerical or symbolic attributes.

In the description below, the set of data is written D={d₁, . . . , dₙ}. The set of attributes is written A={a₁, . . . , aₚ}. Thus, each multivalued datum dᵢ can be represented in attribute space A in the following form:

dᵢ=(a₁(dᵢ); . . . , aₚ(dᵢ)), where aⱼ(dᵢ) is the value taken by attribute aⱼ for datum dᵢ.

The attributes aⱼ may be numerical or symbolic. For example, as shown in FIG. 1, attribute a₁ is numerical. It takes the value 12 for datum d₁ and the value 95 for datum dₙ. Attribute aₚ is symbolic. By way of example, it allocates a color to the database: thus, datum d₁ is of color blue and datum dₙ is of color red.

It is judicious to represent this multivalued database in the form of a table in which each row corresponds to one datum di and in which each column corresponds to one attribute aⱼ.

The computer 10 implements an automatic classification method for classifying the multivalued numerical and/or symbolic data 12 into a descending hierarchy, for the purpose of generating homogeneous classes of data, which classes are accessed with the help of the associated decision tree 14.

A preferred implementation of the invention is to organize the resulting classes into a binary decision tree, i.e. an implementation in which any one data class is subdivided into two subclasses. This particularly simple implementation enables data to be classified quickly and efficiently.

To implement the classification method, the computer 10 has a driver module 16 whose function is to coordinate activation of an input/output (I/O) module 18, a discretization module 20, and a segmentation module 22. By synchronizing these three modules, it enables the decision tree 14 and homogeneous classes to be generated recursively.

The function of the I/O module 18 is to read the data 12 input to the computer 10. In particular, its function is to identify the number of data to be processed and the types of the attributes associated with data, in order to supply them to the discretization module 20.

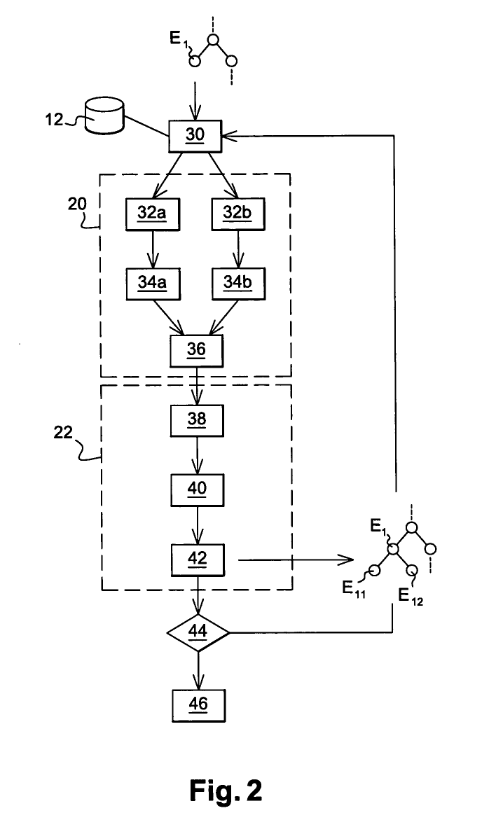

The function of the discretization module 20 is to transform the attributes a₁, . . . aₚ into discrete attributes. More precisely, in this example, the discretization module 20 is a binarization module having the function of transforming each attribute into a binary attribute, i.e. an attribute that can take on only the value “true” or the value “false” for each of the data dᵢ. Its operation is described in detail below with reference to FIG. 2.

The function of the segmentation module 22 is to determine from the binary attributes calculated by the binarization module 20, which attribute is the most discriminating for subdividing a data set into two subsets that are as homogeneous as possible. Its operation is described in detail below with reference to FIG. 2.

The recursive method of automatic classification and of generating an associated decision tree comprises a first step 30 of extracting data from the database 12. During this step, data belonging to a set E₁ are extracted from the database 12, said set being represented by a terminal node of the decision tree 14, and being for subdivision into two subsets E₁₁ and E₁₂.

The data are extracted together with their attributes and the latter are delivered to the input of the binarization module 20 which processes symbolic attributes and numerical attributes separately.

Thus, during a step 32a of estimating a median value, the binarization module 20 calculates for each numerical attribute aⱼ, an estimate of the median value of the following set of values:

{d₁(aⱼ); . . . ; dₙ(aⱼ)}

During this step 32a, it is possible to calculate the median value mⱼ of the set of values taken by the attribute aⱼ directly, however such a calculation can be replaced by a method of estimating this median value, which method is easier to implement by computer means.

This method of estimating the median value Mⱼ comprises the following steps, for example:

the extreme values of the set of values taken by the attribute aⱼ are extracted;

the mean of the remaining values is calculated; and

Mⱼ is given the value of this mean.

The extreme values extracted from the set are constituted, for example, by the n largest values and the n smallest values, where n is a predetermined parameter or is the result of earlier analysis of the distribution of the values taken by the attribute aⱼ.

It is also possible to estimate the median value merely by calculating the mean of all of the values of the attribute.

During the following step 34a of calculating binary attributes, values are calculated for a binary attribute bⱼ on the basis of each numerical attribute aⱼ as follows:

if dᵢ(aⱼ)≦Mⱼ, then dᵢ(bⱼ)=true

if dᵢ(aⱼ)>Mⱼ, then dᵢ(bⱼ)=false

For the symbolic attributes aₖ, the binarization module 20 calculates for each of them an estimate of the modal value of their values. This is implemented during a modal value estimation step 32b.

The modal value Mₖ of a set of symbolic values for an attribute aₖ is the symbolic value that this attribute takes most often.

The modal value Mₖ can be calculated, however that is expensive in terms of computation time.

In order to simplify this step, direct calculation of the modal value can be replaced by a method of estimating it, which method comprises the following steps:

while reading the data of the set E₁, the binarization module 20 stores the m first different symbolic values taken by the data dᵢ for the attribute aₖ, where m is a predetermined number;

the symbolic value which appears most often is retained, amongst said m first different symbolic values; and

this retained symbolic value is allocated to the modal value Mₖ.

By way of example, m is selected to be equal to 200.

If the number of possible symbolic values for the attribute aₖ is less than m, then the estimated modal value Mₖ is equal to the modal value itself. Otherwise, the estimated modal value Mₖ is highly likely to constitute a good replacement value for the modal value in many cases. In general, most symbolic statistical attributes have fewer than several tens of different symbolic values.

During following step 34b for calculating binary attributes, the values of a binary attribute bₖ are calculated from each symbolic attribute aₖ as follows:

if dᵢ(aₖ)=Mₖ, then dᵢ(bₖ)=true

if dᵢ(aₖ)≠Mₖ, then dᵢ(bₖ)=false

Following steps 34a and 34b, the method moves on to a step 36 during which the binary attributes bₖ, bⱼ derived from the symbolic attributes aₖ and the numeric attributes aⱼ are reassembled. This constitutes a set B={b₁, . . . , bₚ} of binary attributes for the set E₁ of data dᵢ. During this step, the binarization module 20 supplies the multivalue data of the set E₁ associated with their binary attributes {b₁, . . . , bₚ} to the segmentation module 22.

Thereafter, during a calculation step 38, the segmentation module 22 calculates for each attribute bⱼ the following value f(bⱼ):

f(bⱼ)=Σ FU(bⱼ,bₖ)

k,k≠j

where:

$$\begin{matrix}FU ( {b}_{j} , {b}_{k} ) = \frac{1}{n} [ c ( {B}_{j} ) Max ( p ( {B}_{k} / {B}_{j} ) ; p ( ⫬ {B}_{k} / {B}_{j} ) ) + \\ c ( ⫬ {B}_{j} ) Max ( p ( {B}_{k} / ⫬ {B}_{j} ) ; p ( ⫬ {B}_{k} / ⫬ {B}_{j} ) ]\end{matrix}$$

where:

for all index j, Bⱼ is the event “the attribute bⱼ takes the value true”; and [symbol] Bⱼ is the event “the attribute Bⱼ takes the value false”;

with Max(x,y): the function that returns the maximum of x and y;

(x/y): the probability of event x, given knowledge of the event y; and

c(x): the number of instances of event x (weighting).

As described above, for each attribute bⱼ, the value f(bⱼ) is an estimate of the expectation that conditional probabilities will correctly predict the other attributes, knowing the value of the attribute bⱼ. In other words, it makes it possible to evaluate the pertinence of segmentation into two subsets based on the attribute bⱼ.

Nevertheless, some other function f could be selected for optimizing segmentation, such as a function based on calculating the covariance of attributes.

During following selection step 40, the segmentation module 22 determines the binary attribute bⱼₘₐₓ which maximizes the value of f(bⱼₘₐₓ), i.e. the attribute which is the most discriminating for segmentation into two subsets.

Thereafter, during a segmentation step 42, the module 22 generates two subsets E₁₁ and E₁₂ from the data set E₁. The first subset E₁₁ is constituted, for example, by a subset combining all of the data for which the attribute bⱼₘₐₓ takes the value true and the second subset E₁₂ groups together all the data of the set E₁ for which the attribute bⱼₘₐₓ takes the value false.

During this step, the decision tree 14 is updated by adding two nodes E₁₁ and E₁₂ connected to the node E₁ by two new branches.

Thus, when moving through this decision tree and on reaching the node E₁, the following test is performed:

“for datum dᵢ, is the attribute aⱼₘₐₓ of a value less than Mⱼₘₐₓ?”, if aⱼₘₐₓ is a numerical attribute; or

“for datum dᵢ, is the attribute aⱼₘₐₓ of a value equal to Mⱼₘₐₓ?”, if aⱼₘₐₓ is a symbolic attribute.

If the response to this test is positive, then datum dᵢ belongs to subset E₁₁, else it belongs to subset E₁₂.

Following step 42, during a test step 44, a criterion for stopping the method is tested. This stop criterion is constituted, for example, by the number of terminal nodes in the decision tree, i.e. the number of classes that have been obtained by the classification method, assuming some fixed number of classes not to be exceeded has been previously established.

The stop criterion could also be the number of levels in the decision tree. Other stop criteria could equally well be devised.

If the stop criterion is reached, then the method moves on to an end-of-method step 46. Otherwise it loops back to step 30 and restarts the above-described method on a new data set, for example the set E₁₁ or the set E₁₂ as previously obtained.

It should be observed that the above-described classification method is a method that is not supervised.

The classification method can also be used in a “semi-supervised” mode. It is useful to apply the classification method in a semi-supervised mode when it is desired to predict or explain a particular attribute as a function of all the others while this particular attribute is badly or sparsely entered in the database 12, i.e. when a large number of data di have no value corresponding to this attribute. Under such circumstances, it suffices to identify this attribute as being purely “to be explained”, and to mark it as such via special marking, for example in an associated parameter file. This attribute which is specified as being “to be explained” by the user is referred to as a “taboo” attribute. The taboo attribute must not be selected as a discriminating attribute.

It should also be observed that a plurality of taboo attributes can be defined. Under such circumstances, it suffices to distinguish among the attributes aⱼ those attributes which are said to be “explanatory” and those attributes which are said to be “taboo”. Taboo attributes are then not selected as discriminating attributes when performing segmentation during above-described step 40.

In semi-supervised mode, during step 40, if the selected attribute is a taboo attribute, then a search is made for the second attribute which maximizes the function f(bⱼ), and so on until the most highly discriminating non-taboo attribute has been found, i.e. the attribute which maximizes the uniformity criterion for the discretized values of the other attributes in the subsets E₁₁ and E₁₂.

The classification as finally obtained can subsequently be used for predicting the values of a taboo attribute for data where the values are missing. The classification method performs tests only on those attributes that are explanatory, while taking maximum advantage of all of the correlations between attributes.

Values for a taboo attribute are predicted by replacing the values that are missing or sparsely entered by the most probable values that are given in each class.

It can clearly be seen that a method of the invention enables classification to be performed simply and efficiently in a descending hierarchy on multivalued numerical and/or symbolic data. Its low level of complexity makes it a suitable candidate for classifying large databases.

What is claimed is:

1. A method of classifying multivalued data stored in data storage means of a computer system in a descending hierarchy, each datum being associated with particular initial values of attributes that are common to the data, the method comprising recursive steps of subdividing data sets, and wherein, during each step of subdividing a set, discrete values are calculated for the attributes from the particular initial values of the data attributes of said set, and wherein said set is subdivided into subsets as a function of a homogeneity criterion calculated on the basis of the discrete values for the attributes of said set.

2. A method of classifying data in a descending hierarchy according to claim 1, wherein during the step of calculation of discrete values for the attributes, each initial attribute is transformed into a discrete attribute.

3. A method of classifying data in a descending hierarchy according to claim 1, wherein, during each step of subdividing a set, binary attribute values are calculated from the particular initial attribute values of the data of said set, and wherein said set is subdivided into subsets as a function of the binary values.

4. A method of classifying data in a descending hierarchy according to claim 3, wherein, during the step of calculating the binary values for the attributes, for each attribute that is numerical, the median value of the particular initial values of said attribute in the data of said set is estimated and in that the value “true” is given to the binary attribute corresponding to said attribute for a datum of said set if the particular initial value of the numerical attribute of said datum is less than or equal to the estimated median value, else the value “false” is given thereto.

5. A method of classifying data in a descending hierarchy according to claim 4, wherein the estimated median value of a numerical attribute is obtained as follows:
extracting extreme values from the set of values taken by the numerical attribute for the data of said set;
calculating the mean of the remaining values; and
allocating the value of said mean as the estimated median value.

6. A method of classifying data in a descending hierarchy according to claim 3, wherein, during the step of calculating the binary values for the attributes, for each attribute that is symbolic, the modal value of the particular initial values of said attribute in the data of said set is estimated, and wherein the value “true” is allocated to the binary attribute corresponding to said attribute for a datum of said set is estimated if the initial particular value of the symbolic attribute of said datum is equal to the estimated modal value, else the value “false” is given thereto.

7. A method of classifying data in a descending hierarchy according to claim 6, wherein the modal value of a symbolic attribute is estimated as follows:
the symbolic values taken by the data of said set for the symbolic attribute are read;
while reading the symbolic values, the first m different symbolic values taken by the data of said set for the symbolic attribute are stored, where m is a predetermined number;
the symbolic value that appears most frequently is retained, amongst said m first different symbolic values; and
the retained symbolic value is used as the estimate of the modal value.

8. A classification method according to claim 1, wherein said set is subdivided on the basis of the discrete values of the most discriminating attribute, i.e. the attribute for which a homogeneity criterion for all of the discrete values of the other attributes in the resulting subsets is optimized.

9. A classification method according to claim 8, wherein, for any attribute, the homogeneity criterion is an estimate of the expectation of the conditional probabilities for correctly predicting the other attributes, given knowledge of this attribute.

10. A classification method according to claim 8, wherein, for certain attributes marked a priori as being “taboo” by means of a particular parameter, the attribute considered as being the most discriminating is the attribute that is not marked as being taboo for which the homogeneity criterion for all of the discrete values of the other attributes in the resulting subsets is optimized.
